(19) United States
(12) Patent Application Publication
(10) Pub. No.: US 2006/0153999 A1
(43) Pub. Date: Jul. 13, 2006

(54) Cast urethane process

(76) Inventors: Shenshen Wu, North Dartmouth, MA (US); Kieran F. Andre, Fairhaven, MA (US); Colin W. Veitch, Fairhaven, MA (US); Calum H. Munro, Wexford, PA (US); Raymond Preston Jones, Mars, PA (US)

Correspondence Address: ACUSHNET COMPANY, 333 BRIDGE STREET, P. O. BOX 965, FAIRHAVEN, MA, 02719, US

(21) Appl. No.: 10/959,808

(22) Filed: Jan. 10, 2005

(51) Int. Cl. G09F 19/00; A47G 35/00

(52) U.S. Cl. 428/11; 428/542.2

(57) ABSTRACT

This invention is directed to translucent and light-stable golf display that is prepared from polyurethane and polyurea compositions. In one embodiment, soft touch coating can be added to a portion of the display. In another embodiment, a color traveling coating can be added. In a different embodiment, both soft touch coating and color traveling coating can be added. the display may encase a partial golf equipment or have the same form factor as golf equipment.

### FIELD OF THE INVENTION

This invention is related to promotional displays of golf balls and golf equipments prepared from polyurethane and polyurea.

### BACKGROUND OF THE INVENTION

Display of merchandise is an important part of the sale. Attractive displays draw attention from potential customers by bringing forth special features and advantages of the merchandise over competing products. For golf balls and golf equipments, several types of displays can be employed.

U.S. Pat. No. 5,715,947 to Gonzales relates to a display case for storing and displaying golf balls. It discloses the use of a plurality of upstanding support members supported on a base wherein each support member has a concave surface to receive a golf ball. The support members have varying heights such that the golf balls are displayed in the shape of a pyramid. A transparent, pyramid-shape cover protects the balls.

U.S. Pat. No. 6,439,424 to Threadgrill, Jr. relates to a portable golf display apparatus having a transparent elongated tubular housing storing a plurality of golf balls. In addition, the housing has a dispensing opening through which a golf player can remove golf balls.

U.S. Pat. No. 6,739,462 to Kelly relates to a display device for golf items. The display has rotary housing with a plurality of vertical and partially open channels storing golf balls. Golf balls are viewable through the partial openings in the channels. In addition, slots for score cards, business cards and pencils are provided.

U.S. Pat. No. 5,511,666 to Grip relates to a sales promotion comprising a tube having top and bottom compartments for golf balls, and a middle compartment for golf tees or related products.

However, there remains a need for displays that show the inner components to promote features and benefits of golf balls and golf equipments.

### SUMMARY OF THE INVENTION

This invention is directed to a translucent golf display comprising a display composition. The display composition can be made of a polyurethane, a copolymer of a polyurethane, a polyurea, or a copolymer of a polyurea, whereby the translucent golf display is castable and light-stable. In one embodiment, a color pigment is added to the composition.

The polyurethane, the copolymer of the polyurethane, the polyurea, and the copolymer of the polyurea can be prepared from an isocyanate, and a polyahl. The isocyanate can be an unsaturated diisocyanate, a saturated diisocyanate, a dimerized uretdione of a diisocyanate, a trimerized isocynurate of a diisocyanate, or a monomeric trisiocyanate. The isocyanate comprises an isocyanate-terminated prepolymer having a percent isocyanate of 0% to less than 14%. The polyahl can be a polyol, a polyamine, a polyamide, a polymercaptan, a polyacid, or a combination thereof. The polyol can be a hydroxy-terminated polyether, a hydroxy-terminated polyester, a hydroxy-terminated polycarprolactone, a hydroxy-terminated polycarbonate, a hydroxy-terminated polyhydrocarbon, or a combination thereof.

In addition, a curing agent can be included, and it can be an unsaturated diol, a saturated diol, an unsaturated triol, a saturated triol, an unsaturated tetraol, a saturated tetraol, a polyol, and a combination thereof, wherein the curing agent has a molecular weight of 50 to 4,000. The curing agent that is a member selected from the group consisting of an unsaturated diamine, a saturated diamine, a triamine, a tetramine, a polyamine, an amine- and hydroxy-containing hybrid curing agent, and a combination thereof, wherein the curing agent has a molecular weight of 50 to 5,000.

The display composition can be used with any golf equipment, such as golf ball, golf club, golf shoe, and golf accessory. A soft touch coating and/or a color traveling coating can be added on a portion of the display, A process of making a translucent golf display is also disclosed.

### BRIEF DESCRIPTION OF THE DRAWINGS

FIG. 1 illustrates a translucent display that encases a partial golf ball.

FIG. 2 illustrates a translucent display that shows the inner and outer surface of one-half of a golf ball cover;

FIG. 3 illustrates a translucent display that shows a muti-layer golf ball; and

FIG. 4 illustrates a translucent display that shows the internal components of a club head.

### DETAILED DESCRIPTION OF THE INVENTION

An appealing display of golf balls and golf equipments is advantageous to their sale. It is particularly useful if a salesperson can describe to potential customers how golf balls and golf equipments are constructed by using promotional displays that show the internal features of these products. In addition, with the display the salesperson can increase the interest of the potential customer by describing the various special features and advantages over competing products.

The present invention is directed to using castable and light-stable materials such as polyurethane and polyurea to make promotional displays of golf balls and golf equipments. Other suitable materials that can be used for this purpose include epoxy, polyamide, and silicone. According to an aspect of the invention, a cast urethane process molds a display of translucent material that encases a partial golf ball to display the inner components thereof.

As used herein, “translucent” includes translucent as well as transparent.

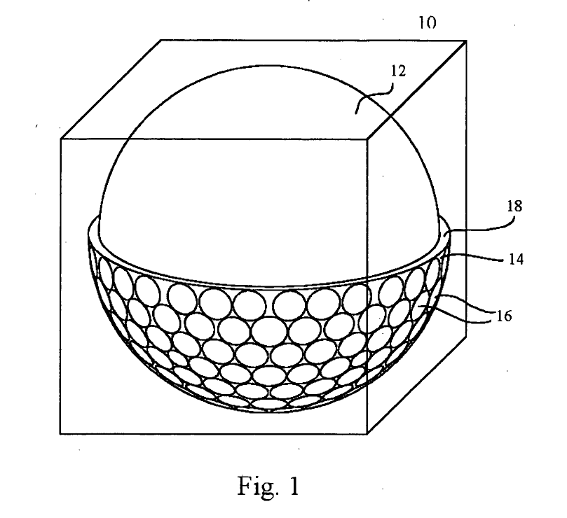

Referring to FIG. 1, a display 10 of a partial golf ball is shown with a core 12, which is covered by a half cover 14 that has dimples 16. The thickness 18 of the cover is clearly shown. The advantages of a relatively large core and thin cover can be readily illustrated. Examples of the overall shape of the display include, but are not limited to, tetrahedron (including pyramid), pentahedron, hexahedron (including cube, as shown), and the like. In addition, sphere, spherical polyhedron and other shapes can be adopted. See Spherical Polyhedron, available at http://mathworld.wolfram.com/SphericalPolyhedron.html.

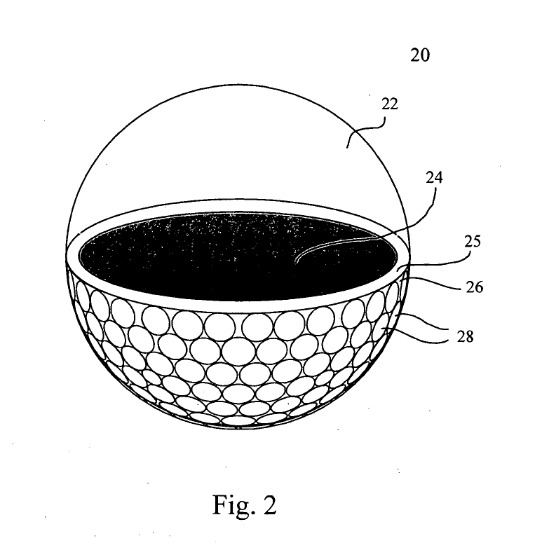

Referring to FIG. 2, golf display 20 comprises a translucent part 22, showing inner surface 24 and outer dimpled surface 26 of half-cover 25 of the outer cover having the outer surface 26. The display is useful in illustrating the dimensions and construction of the outer cover of the golf ball, showing the inner surface 24 and the outer surface 26 with dimples 28. In this embodiment, the display material occupies the space of the omitted core and half cover. the overall shape of display 20 is that of a golf ball, in contrast to the embodiment of FIG. 1 where the display encases a substantially complete golf ball. In other words, the golf display has the same or substantially the same form factor as the golf equipment, e.g., golf ball or golf club.

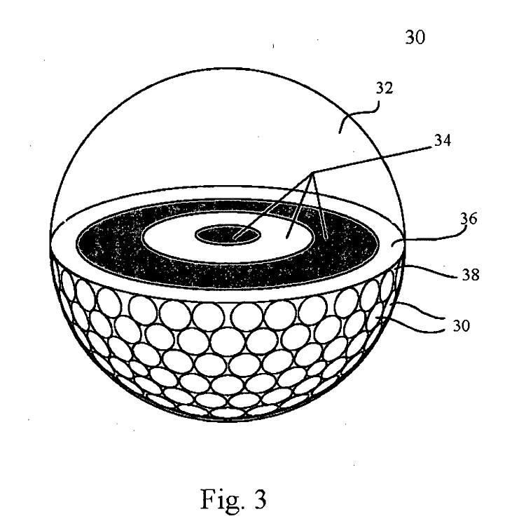

Referring to FIG. 3, golf display 30 comprises a translucent semi-hemispherical part 32, showing a plurality of inner layers 34, an outer cover 36 having an outer surface 38 with dimples 39.

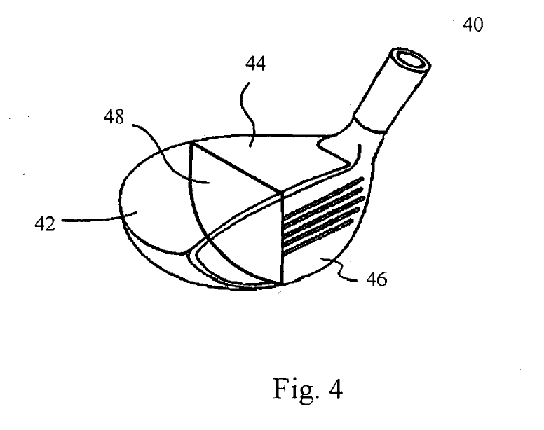

Referring to FIG. 4, golf display 40 comprises a translucent portion 42, and a partial club head comprising partial crown 44 and partial striking surface 46. The display 40 is helpful in illustrating the dimension and construction of the club head, showing the interior 48 of the club head. Translucent portion 42 may extend into the partial clubhead. Alternatively, translucent portion 42 may completely encase the partial clubhead, similar to the embodiment of FIG. 1.

The castable and light-stable material comprises a polyurethane, a copolymer of a polyurethane, a polyurea, or copolymer of a polyurea. The polyurethane, the copolymer of the polyurethane, the polyurea, or the copolymer of the polyurea can be prepared from an isocyanate and a polyahl. The isocyanate can either be aromatic or aliphatic, or a combination thereof. The aliphatic isocyanate is preferred because of its color stability under light exposure.

Any isocyanate available to one of ordinary skill in the art is suitable for use according to this invention. The isocyanate may be organic, modified organic, saturated, aliphatic, alicyclic, unsaturated, araliphatic, aromatic, substituted, or unsubstituted diisocyanate or polyisocyanate monomers having two or more free reactive isocyanate (“NCO”) groups, isomers thereof, modified derivatives thereof, dimers thereof, trimers thereof, or isocyanurates thereof.

The isocyanate may also include any isocyanate-containing multimeric adducts, oligomers, polymers, prepolymers, low-free-isocyanate monomer prepolymers, quasi-prepolymers, and modified polyisocyanates derived from the above-isocyanates and polyisocyanates.

The preferred isocyanates include diisocyanates (having two NCO groups per molecule), dimerized uretdiones thereof, trimerized isocyanurates thereof, and polyisocyanates such as monomeric triisocyanates. Any and all of the isocyanates disclosed herein may be used alone or in combination of two or more thereof.

Diisocyanates typically have the generic structure of O═C═N—R—N═C═O, where R is a cyclic, aromatic, aliphatic, linear, branched, or substituted hydrocarbon moiety containing from 1 to about 20 carbon atoms, such as arylenes, aralkylenes, alkylenes, or cycloalkylenes. When multiple cyclic or aromatic groups are present, linear, branched or substituted hydrocarbons containing from 1 to about 10 carbon atoms can be present as spacers between such cyclic or aromatic groups. In some cases, the cyclic or aromatic group(s) may be substituted at the 2- (ortho-), 3- (meta-), and/or 4- (para-) positions. Substituted groups may include, but are not limited to, halogens, cyano group, amine groups, silyl groups, hydroxyl groups, acid groups, alkoxy groups, primary or secondary or tertiary hydrocarbon groups, or a combination of two or more groups thereof.

Suitable examples of unsaturated diisocyanates include, but are not limited to:
(1) para-phenylene diisocyanate (“PPDI,” i.e., 1,4-phenylene diisocyanate), meta-phenylene diisocyanate (“MPDI,” i.e., 1,3-phenylene diisocyanate), ortho-phenylene diisocyanate (i.e., 1,2-phenylene diisocyanate), 4-chloro-1,3-phenylene diisocyanate,
(2) toluene diisocyanate (“TDI”), meta-tetramethylxylene diisocyanate (“m-TMXDI”), para-tetramethylxylene diisocyanate (“p-TMXDI”), ortho-, meta-, and para-xylene diisocyanates,
(3) 2,2′-, 2,4′-, and 4,4′-biphenylene diisocyanates, 3,3′-dimethyl-4,4′-biphenylene diisocyanate (“TODI”),
(4) 2,2′-, 2,4′-, and 4,4′-diphenylmethane diisocyanates (“MDI”), 3,3′-dimethyl-4,4′-diphenylmethane diisocyanate, carbodiimide-modified MDI, polymeric MDI (PMDI, a brown liquid composed of approximately 50% methylene diisocyanate with the remainder comprised of oligomers of MDI),
(5) 1,5-naphthalene diisocyanate (NDI), 1,5-tetrahydronaphththalene diisocyanate, anthracene diisocyanate, tetracene diisocyanate,
(6) 2,3,5,6-tetramethyl-1,4-diisocyanatobenzene (durene diisocyanate),
(7) o-xylylene diisocyanate (XDI), m-xylylene diisocyanate (XDI), p-xylylene diisocyanate (XDI), and the like.

Suitable examples of saturated diisocyanates include, but are not limited to:
(1) 1,4-tetramethylene diisocyanate, 1,5-pentamethylene diisocyanate, 2-methyl-1,5-pentamethylene diisocyanate, 1,6-hexamethylene diisocyanate (“HDI”) and isomers thereof, 2,2,4- and 2,4,4-trimethylhexamethylene diisocyanates, 1,7-heptamethylene diisocyanate and isomers thereof, 1,8-octamethylene diisocyanate and isomers thereof, 1,9-novamethylene diisocyanate and isomers thereof, 1,10-decamethylene diisocyanate and isomers thereof, 1,12-dodecane diisocyanate and isomer thereof,
(2) 1,3-cyclobutane diisocyanate, 1,2-, 1,3-, and 1,4-cyclohexane diisocyanates, 2,4- and 2,6-methylcyclohexane diisocyanates (“HTDI”),
(3) isophorone diisocyanate (“IPDI”), isocyanatomethylcyclohexane isocyanate, isocyanatoethylcyclohexane isocyanate, 1,2-, 1,3-, and 1,4-bis-(isocyanatomethyl)cyclohexane, 1-isocyanatocyclohexane,
(4) 1,3-bis-(1-isocyanato-1-methylethyl)-cyclohexane (hydrogenated version of m-TMXDI),
(5) 4,4′-dicyclohexylmethane diisocyanate (“H₁₂MDI,” a.k.a. bis(4-isocyanatocyclohexyl)-methane), 2,4′- and 4,4′-dicyclohexane diisocyanates, 2,4′- and 4,4′-bis(isocyanatomethyl) dicyclohexanes, and the like.

Dimerized uretdiones of diisocyanates and polyisocyanates include, for example, unsaturated isocyanates such as uretdiones of toluene diisocyanates, uretdiones of diphenylmethane diisocyanates, and saturated isocyanates such as uretdiones of hexamethylene diisocyanates.

Trimerized isocyanurates of diisocyanates and polyisocyanates include, for example, unsaturated isocyanates such as isocyanurates of diphenylmethane diisocyanate, isocyanurates of tetramethylxylene diisocyanate, isocyanurates of toluene diisocyanates, and saturated isocyanates such as isocyanurates of isophorone diisocyanate, isocyanurates of hexamethylene diisocyanate, HDI biuret prepared from HDI, isocyanurates of trimethyl-hexamethylene diisocyanates.

Monomeric triisocyanates include, for example, unsaturated isocyanates such as 2,4,4′-diphenylene triisocyanate, 2,4,4′-diphenylmethane triisocyanate, 4,4′,4″-triphenylmethane triisocyanate, and saturated isocyanates such as 1,3,5-cyclohexane triisocyanate, 3-isocyanatomethyl-1,6-hexamethylene diisocyanate, and isomers of triisocyanatononane.

Among the above-listed isocyanates, all of the saturated isocyanates display satisfactory light stability when used in golf balls, and are preferred in golf ball cover, and coating compositions. Other light-stable isocyanates include some of the unsaturated isocyanates, particularly those that are araliphatic, including 1,2-, 1,3-, and 1,4-xylene diisocyanates, meta-tetramethylxylene diisocyanate, para-tetramethylxylene diisocyanate, uretdiones of toluene diisocyanates, isocyanurates of toluene diisocyanates, and isocyanurates of diphenylmethane diisocyanates.

Isocyanate-containing oligomers and polymers include any oligomers and polymers having two or more free reactive isocyanate groups as terminal groups and/or pendent groups on the oligomeric or polymeric backbones. Isocyanate-terminated prepolymers and quasi-prepolymers are well known to the skilled artisan, and include, but are not limited to, the reaction products of any one or more of the isocyanates and any one or more of the hydroxyl-terminated and/or amine-terminated compounds disclosed herein.

The isocyanate suitable for the present invention may have any amount of percent isocyanate (NCO). The term “percent NCO,” or “% NCO,” refers to the percent by weight of free, reactive, and unreacted isocyanate functional groups in an isocyanate-functional molecule or material. The total atomic weight of all the NCO groups in the molecule or material, divided by its total molecular weight, and multiplied by 100, equals the percent NCO. In one embodiment, the isocyanate comprises an isocyanate-terminated prepolymer having no greater than about 14% NCO, preferably no greater than about 10% NCO, and more preferably no greater than about 7%. The % NCO can be as low as about 0%, in which case, the prepolymer does not contain unreacted isocyanate functional groups. The current invention applies to prepolymers having % NCO in the range from about 0% to less than about 14%. It is well understood in the art that material hardness of polyureas, polyurethanes, and polyurethane/polyurea hybrids can readily be modified by adjusting the percent NCO content in the isocyanate-terminated prepolymer.

The polyurethane, the copolymer of the polyurethane, the polyurea, and the copolymer of the polyurea may be prepared from a polyahl. As defined in U.S. Pat. No. 4,594,364 to Pawloski, et al., the term “polyahl” includes any organic compound having at least two active hydrogen moieties and an average molecular weight of at least 62. Illustrative of such active hydrogen moieties are —COOH, —OH, NH₂, =NH, —CONH₂, —SH and —CONH—. Typical polyahls include polyols, polyamines, polyamides, polymercaptans, polyacids, and the like.

Suitable polyols and polyamines for use in the invention are listed below. The polyahl suitable for the present invention may be organic, modified organic, saturated, aliphatic, alicyclic, unsaturated, araliphatic, aromatic, substituted, or unsubstituted. The polyahl preferably has two or more reactive hydrogen groups per molecule, such as primary or secondary hydroxyl groups or amine groups, and at least one cyclic, aromatic, aliphatic, linear, branched, or substituted hydrocarbon moiety containing from 1 to about 20 carbon atoms, such as arylenes, aralkylenes, alkylenes, or cycloalkylenes. When multiple cyclic or aromatic groups are present, linear, branched or substituted hydrocarbons containing from 1 to about 10 carbon atoms can be present as spacers between such cyclic or aromatic groups. In some cases, the cyclic or aromatic group(s) may be substituted at the 2- (ortho-), 3- (meta-), and/or 4- (para-) positions. Substituted groups may include, but are not limited to, halogens, cyano groups, amine groups, silyl groups, hydroxyl groups, acid groups, alkoxy groups, primary or secondary or tertiary hydrocarbon groups, or a combination of two or more groups thereof. Any and all of the polyahls disclosed herein may be used alone or in combination of two or more thereof.

The polyahl may be hydroxy- and/or amine-terminated oligomers or polymers preferably used in forming a prepolymer with the isocyanate, or hydroxy- and/or amine-containing compounds reactive to the prepolymer or the isocyanate, preferably used as curing agents for chain-extension and/or crosslink. The hydroxy- and/or amine groups may be terminal or pendant groups on the oligomeric or polymeric backbone, and in the case of secondary amine groups, may even be embedded within the backbone.

Suitable hydroxy-terminated oligomers or polymers has a molecular weight of at least about 200 and at least two primary or secondary hydroxyl terminal groups per molecule, and include, but are not limited to: (a) hydroxy-terminated polyethers, (b) hydroxy-terminated polyesters, (c) hydroxy-terminated polycarprolactones, (d) hydroxy-terminated polycarbonates, (e) hydroxy-terminated polyhydrocarbons, (6) hydroxy-terminated oligomers or polymers, and any combination thereof.

Suitable examples of hydroxy-terminated polyethers include, but are not limited to polytetramethylene ether glycol (“PTMEG”), low-molecular-weight PTMEG, modified PTMEG, hydroxyl-terminated copolymer of polytetrahydrofuran and polymethyltetrahydrofuran (“PTG-L”), poly(oxyethylene)glycol, poly(oxypropylene)glycol, (ethylene oxide)-capped poly(oxypropylene) ether glycol, poly(oxyethylene-co-oxypropylene) glycol, 2-ethyl-2-(hydroxymethyl)-1,3-propanediol, and the like.

Suitable examples of hydroxy-terminated polyesters include, but are not limited to poly(ethylene adipate) glycol, poly(propylene adipate) glycol, poly(butylene adipate) glycol, poly(hexamethylene adipate) glycol, poly(ethylene propylene adipate) glycol, poly(ethylene butylene adipate) glycol, poly(hexamethylene butylene adipate) glycol, propylene glycol-based alkylhexahydrophthalic polyester polyols, propylene glycol-based alkyltetrahydrophthalic polyester polyols, dipentaerythritol-based alkylhexahydrophthalic polyester polyols, dipentaerythritol-based alkyltetrahydrophthalic polyester polyols, (o-phthalate-1,6-hexanediol)-based polyester polyol, poly(ethylene terephthalate)-based polyester polyol, and the like.

Suitable examples of hydroxy-terminated polycaprolactones include, but are not limited to (alkylene oxide)-initiated polycaprolactones, (ethylene glycol)-initiated polycaprolactone, (diethylene glycol)-initiated polycaprolactone, (propylene glycol)-initiated polycaprolactone, (dipropylene glycol)-initiated polycaprolactone, 1,4-butanediol-initiated polycaprolactone, trimethylolpropane-initiated polycaprolactone, (neopentyl glycol)-initiated polycaprolactone, 1,6-hexanediol-initiated polycaprolactone, PTMEG-initiated polycaprolactone, 2-ethyl-2-(hydroxymethyl)-1,3-propanediol initiated polycaprolactone, and the like.

Suitable examples of hydroxy-terminated polycarbonates include, but are not limited to poly(phthalate carbonate) glycol, poly(hexamethylene carbonate) glycol, poly(1,4-cyclohexanedimethylene carbonate) glycol, (bisphenol A)-based polycarbonate glycols, and the like.

Suitable examples of hydroxy-terminated polyhydrocarbons include, but are not limited to polyisoprene polyol (i.e., liquid isoprene rubber), poly(hydrogenated isoprene) polyol, polybutadiene polyol, poly(hydrogenated butadiene) polyol, and the like.

Suitable examples of hydroxy-terminated acid functional oligomers or polymers (or ionomers thereof derived from partial or full neutralization with organic or inorganic cations), include acid functional polyols as disclosed in commonly-owned U.S. Pat. No. 6,207,784 to Rajagopalan.

Other hydroxy-terminated polymers such as hydroxy-terminated polyolefins, hydroxy-terminated polyamides, glycerol-based polyols, (castor oil)-based polyols, hydroxy-terminated alkylene-styrene copolymers (i.e., Kraton® polyols), and hydroxy-terminated acrylic polyols.

Saturated members of the above-listed hydroxy-terminated oligomers or polymers are preferred for use in the present invention, because they afford superior light stability when incorporated into the golf ball cover composition. Saturated hydroxy-terminated polymers may be aliphatic, alicyclic, or fully hydrogenated. Suitable examples of saturated hydroxy-terminated polymers include, but are not limited to, PTMEG, low-molecular-weight PTMEG, modified PTMEG, PTG-L, poly(oxyethylene)glycol, poly(oxypropylene)glycol, (ethylene oxide)-capped poly(oxypropylene) ether glycol, poly(ethylene adipate) glycol, poly(butylene adipate) glycol, poly(hexamethylene adipate) glycol, poly(ethylene propylene adipate) glycol, poly(ethylene butylene adipate) glycol, poly(hexamethylene butylene adipate) glycol, (alkylene oxide)-initiated polycaprolactones, (ethylene glycol)-initiated polycaprolactone, (diethylene glycol)-initiated polycaprolactone, (propylene glycol)-initiated polycaprolactone, (dipropylene glycol)-initiated polycaprolactone, 1,4-butanediol-initiated polycaprolactone, trimethylolpropane-initiated polycaprolactone, (neopentyl glycol)-initiated polycaprolactone, 1,6-hexanediol-initiated polycaprolactone, PTMEG-initiated polycaprolactone, poly(hexamethylene carbonate) glycol, saturated poly(hydrogenated isoprene) polyol, saturated poly(hydrogenated butadiene) polyol, saturated dimerate or trimerate polyols of fatty acids or isostearic acid, saturated hydroxy-terminated polyolefins, saturated hydroxy-terminated polyamides, saturated glycerol-based polyols, saturated (castor oil)-based polyols, and saturated hydroxy-terminated alkylene-styrene copolymers.

Suitable amine-terminated oligomers or polymers preferably has a molecular weight of at least about 200 and at least two primary or secondary amine terminal groups per molecule. Because lower molecular weight amine-terminated polymers may be prone to forming solids, a high molecular weight between about 1,000 and about 5,000 is more preferred. Suitable examples of amine-terminated oligomers or polymers include, but are not limited to: (a) amine-terminated polyethers, (b) amine-terminated polymers, (c) amine-terminated polycaprolactones, (d) amine-terminated polycarbonates, (e) amine-terminated polyhydrocarbons, (f) amine-terminated acid functional polymers, (g) amine-terminated polyolefins, (h) amine-terminated polyamides, (i) amine-terminated polyacrylics, and any combination thereof.

Suitable examples of amine-terminated polyethers include, but are not limited to polyoxyalkylene diamines, polyoxyethylene diamines, polyoxypropylene diamines, polyoxypropylene triamine, poly(tetramethylene ether) diamines, (ethylene oxide)-capped polyoxypropylene ether diamines, poly(triethyleneglycol) diamines, poly(trimethylolpropane) triamines, polyethyleneglycol-di(p-aminobenzoate), polytetramethyleneoxide-di(p-aminobenzoate), glycerin-based triamines, and the like.

Examples of other amine-terminated polymers, such as amine-terminated polyesters, amine-terminated polycaprolactones, amine-terminated polycarbonates, amine-terminated polyhydrocarbons, amine-terminated acid functional polymers, amine-terminated polyolefins, amine-terminated polyamides, and amine-terminated polyacrylics, preferably can be prepared from the above-listed hydroxyl-terminated polymers using methods described in U.S. Pat. App. Publication 2002/0132915 by Pantone et al., which is incorporated by reference in its entirety. These methods include, for example, (1) reductive amination of polyether polyols with ammonia and hydrogen in the presence of a catalyst (U.S. Pat. Nos. 5,015,773, 5,003,107, and 3,654,370), (2) hydrogenation of cyanoethylated polyols, (3) amination of polyol/sulfonic acid esters (U.S. Pat. No. 3,236,895), (4) reacting polyols with epichlorohydrin and a primary amine, or (5) those listed in the publication “Jeffamine, Polyoxypropylene Amines” by Texaco Chemical Co., 1978.

Saturated members of the above-listed amine-terminated polymers are preferred for use in the present invention, because they afford superior light stability when incorporated into the golf ball cover compositions. Saturated amine-terminated polymers may be aliphatic, alicyclic, or fully hydrogenated. Suitable examples of saturated amine-terminated polymers include, but are not limited to polyoxyalkylene diamines, polyoxyethylene diamines, polyoxypropylene diamines, polyoxypropylene triamine, poly(tetramethylene ether) diamines, (ethylene oxide)-capped polyoxypropylene ether diamines, poly(triethyleneglycol) diamines, poly(trimethylolpropane) triamines, saturated glycerin-based triamines, saturated amine-terminated polyesters, saturated amine-terminated polycaprolactones, saturated amine-terminated polycarbonates, saturated amine-terminated polyhydrocarbons, saturated amine-terminated acid functional polymers, saturated amine-terminated polyolefins, saturated amine-terminated polyamides, and saturated amine-terminated polyacrylics.

Suitable curing agents for use in this invention include: (a) unsaturated diols, (b) saturated diols, (c) unsaturated triols, (d) saturated triols, (e) unsaturated tetraols, (f) saturated tetraols, (g) polyols, (h) unsaturated diamines, (i) saturated diamine, (j) triamines, (k) tetramines, (l) polyamines, (m) amine- and hydroxy-containing hybrid curing agents, and a combination thereof.

In general, suitable hydroxy-containing curing agents have a molecular weight of about 50 to about 4,000, and suitable amine-containing curing agents have a molecular weight of about 50 to about 5,000.

Suitable examples of unsaturated diols include, but are not limited to:
(1) 1,3-bis(2-hydroxyethoxy)benzene, 1,3-bis[2-(2-hydroxyethoxy)ethoxy]benzene, 1,3-bis {2-[2-(2-hydroxyethoxy)ethoxy]ethoxy}benzene,
(2) N,N-bis(β-hydroxypropyl)aniline,
(3) hydroquinone-di(β-hydroxyethyl)ether, resorcinol-di(β-hydroxyethyl)ether,
(4) ethoxylates of the bis-phenols, bis(2-hydroxyethyl) bisphenol,
(5) tetramethylxylylene diols, xylene glycol, and the like.

Suitable examples of saturated diols include, but are not limited to:
(1) ethylene glycol, diethylene glycol, polyethylene glycol, propylene glycol, dipropylene glycol, polypropylene glycol, 2-methyl-1,3-propanediol, 1,2-, 1,3-, 1,4-, or 2,3-butanediols, 2-methyl-1,4-butanediol, 2,3-dimethyl-2,3-butanediol, 1,5-pentanediol, neopentyl glycol, 1,6-hexanediol, trimethylolpropane,
(2) 1,4-cyclohexyldimethylol,
(3) 1,3-bis(2-hydroxyethoxy)cyclohexane, 1,3-bis[2-(2-hydroxyethoxy)ethoxy]cyclohexane, 1,3-bis{2-[2-(2-hydroxyethoxy)ethoxy] ethoxy} cyclohexane,
(4) PTMEG having a molecular weight of about 200 to about 4000, and the like.

Suitable examples of unsaturated triols include, but are not limited to: castor oil (i.e., triricinoleoyl glycerol), and the like.

Suitable examples of saturated triols include, but are not limited to 1,2,4-butanetriol, 1,2,6-hexanetriol, trimethylolethane (i.e., 1,1,1-tri(hydroxymethyl)ethane), trimethylolpropane (i.e., 2,2-di(hydroxymethyl)-1-butanol), triethanolamine, triisopropanolamine, and the like.

Suitable examples of unsaturated tetraols include, but are not limited to 2-propanol-1,1′-phenylamino-bis, 2,4,6-tris(N-methyl-N-hydroxymethylaminomethyl)phenol and the like.

Suitable examples of saturated tetraols include, but are not limited to pentaerythritol (i.e., tetramethylolmethane), tetrahydroxypropylene ethylenediamine (i.e., N,N,N′,N′-tetrakis(2-hydroxypropyl)-ethylenediamine).

Suitable examples of polyols include, but are not limited to mannitol (i.e., 1,2,3,4,5,6-hexanehexol), sorbitol (an enantiomer of mannitol) (both saturated), and the like.

Suitable examples of unsaturated diamines include, but are not limited to:
(1) m-phenylenediamine, o-phenylenediamine, p-phenylenediamine, 2,4- and 2-6-toluene diamine, 1,2-, 1,3-, or 1,4-bis(sec-butylamino)benzene (Unilink 4100), 3,3′-dimethyl-4,4′-biphenylene diamine, 1,2-, 1,3-, or 1,4-bis(sec-butylamino) xylene,
(2) 3,5-diethyl-(2,4- or 2,6-)toluenediamine, 3,5-dimethylthio-(2,4- or 2,6-)toluenediamine, 3,5-diethylthio-(2,4- or 2,6-)toluenediamine,
(3) 4,4′-diamino-diphenylmethane (i.e., 4,4′-methylene-dianiline or “MDA”), 3,3′-dimethyl-4,4′-diamino-diphenylmethane, 3,3′-diethyl-5,5′-dimethyl-4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′-diethyl-5,5′-dichloro-4,4′-diamino-diphenylmethane, 3,3′,5,5′-tetraethyl-4,4′-diamino-diphenylmethane (i.e., 4,4′-methylene-bis(2,6-diethylaniline) or “MDEA”), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-dichloro-4,4′-diamino-diphenylmethane, 2,2′,3,3′-tetrachloro-4,4′-diamino-diphenylmethane (i.e., 4,4′-methylene-bis(2,3-dichloroaniline) or “MDCA”), 3,3′-dichloro-2,2′,6,6′-tetraethyl-4,4′-diaminodiphenylmethane, 4,4′-bis-(sec-butylamino)-diphenylmethane (Unilink 4200), 3,3′-dimethyl-4,4′-bis-(sec-butylamino)-diphenylmethane, N,N′-dialkylamino-diphenylmethane, 3,3′,5,5′-tetraisopropyl-4,4′-diaminodiphenylmethane, 3,3′-dimethyl-5,5′-diisopropyl-4,4′-diaminodiphenylmethane, 3,3′-diethyl-5,5′-diisopropyl-4,4′-diaminodiphenylmethane, 3,3′-dimethyl-5,5′-di-t-butyl-4,4′-diaminodiphenylmethane, and isomers thereof,
(4) trimethyleneglycol-di(p-aminobenzoate), polyethyleneglycol-di(p-aminobenzoate), polytetramethyleneglycol-di(p-aminobenzoate),
(5) 2,3,5,6-tetramethyl-1,4-diaminobenzene,
(6) m-xylene diamine, m-tetramethylxylene diamine, and the like.

Suitable examples of saturated diamines include, but are not limited to:
(1) ethylene diamine, 1,3-propylene diamine, 2-methyl-pentamethylene diamine, 1,3-pentanediamine, hexamethylene diamine, 2,2,4- and 2,4,4-trimethyl-1,6-hexane diamine,
(2) imino-bis(propylamine), methylimino-bis(propylamine) (i.e., N-(3-aminopropyl)-N-methyl-1,3-propanediamine), 1,12-dodecanediamine,
(3) 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxatridecane-1,13-diamine, polyoxyethylene diamines, polyoxypropylene diamines, (ethylene oxide capped)-polyoxypropylene ether diamines, polytetramethylene ether diamines,
(4)1,4-diamino-cyclohexane, 1,3-diamino-cyclohexane, 1,2-diamino-cylcohexane, 1,4-diaminoethylcyclohexane, 1-methyl-3,5-diethyl-2,4 (2,6)-diaminocyclohexane, 1-methyl-3,5-dimethylthio-2,4 (2,6)-diaminocyclohexane, 1-methyl-2,6-diamino-cyclohexane, 1,2-, 1,3-, or 1,4-bis(methylamino)-cyclohexane, 1,2-, 1,3-, or 1,4-bis(sec-butylamino)-cyclohexane, 1,2-, 1,3-, or 1,4-bis(sec-butylamino methyl)-cyclohexane, isophorone diamine,
(5) 4,4′-diamino-dicyclohexylmethane, 3,3′-dimethyl-4,4′-diamino-dicyclohexylmethane, 3,3′-diethyl-5,5′-dimethyl-4,4′-diamino-dicyclohexylmethane, 3,3′-dichloro-4,4′-diamino-dicyclohexylmethane, 3,3′-diethyl-5,5′-dichloro-4,4′-diamino-dicyclohexylmethane, 3,3′,5,5′-tetraethyl-4,4′-diamino-dicyclohexylmethane (i.e., 4,4′-methylene-bis(2,6-diethylaminocyclohexane)), 2,2′-dichloro-3,3′,5,5′-tetraethyl-4,4′-diamino-dicyclohexylmethane, 3,3′-dichloro-4,4′-diamino-dicyclohexylmethane, 2,2′,3,3′-tetrachloro-4,4′-diamino-dicyclohexylmethane, 3,3′-dichloro-2,2′,6,6′-tetraethyl-4,4′-dicyclohexylmethane, 4,4′-bis(sec-butylamino)-dicyclohexylmethane (Clearlink® 1000), N,N′-dialkylamino-dicyclohexylmethane, 3,3′-dimethyl-4,4′-bis(sec-butylamino)-dicyclohexylmethane (Clearlink® 3000), N,N′-diisopropyl-isophorone diamine (Jefflink® 754), 3-{[(5-amino-1,3,3-trimethylcyclohexyl)methyl]amino}-propanenitrile, N,N′-diethylmaleate-2-methyl-pentamethylene diamine (Desmophen® NH 1220), N,N′-di(ethylmaleate-amino)-dicyclohexylmethane (Desmophen® NH 1420), N,N′-di(ethylmaleate-amino)-dimethyl-dicyclohexylmethane (Desmophen® 1520), polyamine/carbonyl adducts,
(6) 1-methyl-3,5-dimethylthio-(2,4- or 2,6-)cyclohexyldiamine, 1-methyl-3,5-diethyl-(2,4- or 2,6)cyclohexyldiamine,
(7) N-aminoethylpiperazine, 1,2-, 1-3,1,4-bis-(isocyanatomethyl) cyclohexane,
(8) 2,3,5,6-tetramethyl-1,4-diaminocyclohexane,
(9) 3-bis-(1-amino-1-methylethyl)-cyclohexane (hydrogenated version of m-TMXDA), and the like.

Suitable examples of triamines include, but are not limited to: diethylene triamine, dipropylene triamine, (propylene oxide)-based triamines (i.e., polyoxypropylene triamines), trimethylolpropane-based triamines, glycerin-based triamines, N-(2-aminoethyl)-1,3-propylenediamine (i.e., N₃-amine) (all saturated), and the like.

Suitable examples of tetramines include, but are not limited to triethylene tetramine, N,N′-bis(3-aminopropyl)ethylenediamine (i.e., N₄-amine) (both saturated), and the like.

Suitable examples of polyamines include, but are not limited to tetraethylene pentamine (also saturated), and the like.

Suitable amine- and hydroxy-containing hybrid curing agents may be monomeric, oligomeric, or polymeric, having at least one free reactive hydroxyl group and at least one free reactive amine group. The hydroxyl and amine groups may be terminal or pendant groups on the oligomeric or polymeric backbone, and in the case of secondary amine groups, may even be embedded within the backbone. Suitable examples of hydroxy- and amine-containing hybrid curing agents include, but not limited to: monoethanolamine, monoisopropanolamine, diethanolamine, and diisopropanolamine.

Saturated members of the above-listed hydroxy- and/or amine-containing polymers are preferably chosen to react with the saturated prepolymers formed from the saturated isocyanates and the saturated hydroxy- or amine-terminated polymers and form saturated polyurethane, polyurea, or copolymers thereof for light-stable displays.

The most preferred saturated curatives are 1,4-butanediol, 2-methyl-1,3-propanediol, 2-methyl-1,4-butanediol, 2,3-dimethyl-2,3-butanediol, 1,4-cyclohexyldimethylol, 4,4′-bis-(sec-butylamino)-dicyclohexylmethane, and 3,3′-dimethyl-4,4′-bis(sec-butylamino)-dicyclohexylmethane.

The golf displays of the present invention can have any shape that can be compression or injection molded with the liquid castable materials. For instance, the golf display can resemble golf shafts, golf shoe components, golf putters, etc., to show internal features thereof. In addition, the invention can be adapted to include coatings with soft touch and/or color traveling effects to be part of the display of golf products. Copending U.S. patent application Ser. No. 10/901,628 directed to soft touch coating materials, and U.S. patent application Ser. No. 10/901,632 directed to color traveling coating materials are incorporated by reference in their entirety.

Color pigments known in the art are preferably omitted from the display material to maintain the translucent property of the display, but can be selectively added to enhance the visual quality of the display. For instance, coating compositions using nanopigments are suitable to add to the translucent display of this invention. According to U.S. Pat. App. Publication 2003/0125417 Vanier et al., which is incorporated by reference in its entirety, nanosized colorants having low haze (i.e. high transparency) and a narrow absorbance bandwidth in the visible spectrum can be used.

### EXAMPLES

Castable and Light-Stable Polyurethane Formulation I

The prepolymer is Airthane WCM 600 @ 7.02% NCO, manufactured by Air Products and Chemicals, Inc. The curative blend contains 1,4-cyclohexanedimethylol, 0.45% Dabco T-12, and 3.5% HCC-19584 White Dispersion that is manufactured by The PolyOne Corporation.

Process I

The prepolymer and the curative blend were heated to 145° F. and mixed in the dynamic mixer for about 22 seconds. The mixed material is then dispensed into a dimpled half mold maintained at 180° F. When the gel time (viscosity range between 15,000 to 30,000 cps) of the mixed material is reached, the dimpled half cup is mated under pressure with a half mold containing a core plug also maintained at 180° F. After about 30 minutes of post curing at ambient temperature, the part is demolded. A suitable display is produced by using a die to trim off the flash.

Castable and Light-Stable Polyurethane Formulation II

The prepolymer is APC-504 @ 7.96% NCO manufactured by Air Products and Chemicals, Inc. The curative blend contains 1,4-cyclohexanedimethylol, 0.05% Dabco T-12, and 3.5% HCC-19584 White Dispersion that is manufactured by The PolyOne Corporation.

Process II

Formulation II was then treated in a process that is identical to Process I.

Other than in the operating examples, or unless otherwise expressly specified, all of the numerical ranges, amounts, values and percentages such as those for amounts of materials, and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

While it is apparent that the illustrative embodiments of the invention disclosed herein fulfill the preferred embodiments of the present invention, it is appreciated that numerous modifications and other embodiments may be devised by those skilled in the art. Examples of such modifications include slight variations of the numerical values discussed above. Hence, the numerical values stated above and claimed below specifically include those values and the values that are approximately or nearly close to the stated and claimed values. Therefore, it will be understood that the appended claims are intended to cover all such modifications and embodiments, which would come within the spirit and scope of the present invention.

What is claimed is:

1. A golf display comprising a translucent display composition and a partial golf equipment, wherein
the display composition comprises a polyurethane, a copolymer of a polyurethane, a polyurea, or a copolymer of a polyurea,
whereby the translucent golf display is castable and light-stable.

2. The golf display of claim 1, wherein the translucent display encases the partial golf-equipment.

3. The golf display of claim 1, wherein the golf display has substantially the same form factor as the golf equipment.

4. The golf display of claim 1, wherein the polyurethane, the copolymer of the polyurethane, the polyurea, or the copolymer of the polyurea are prepared from an isocyanate, and a polyahl.

5. The golf display of claim 4, wherein the isocyanate is a member selected from the group consisting of an unsaturated diisocyanate, a saturated diisocyanate, a dimerized uretdione of a diisocyanate, a trimerized isocynurate of a diisocyanate, and a monomeric trisiocyanate.

6. The golf display of claim 4, wherein the isocyanate comprises an isocyanate-terminated prepolymer having a percent isocyanate from 0% to less than 14%.

7. The golf display of claim 4, wherein the polyahl is a member selected from the group consisting of a polyol, a polyamine, a polyamide, a polymercaptan, a polyacid, and a combination thereof.

8. The golf display of claim 7, wherein the polyol is a member selected from the group consisting of a hydroxy-terminated polyether, a hydroxy-terminated polyester, a hydroxy-terminated polycarprolactone, a hydroxy-terminated polycarbonate, a hydroxy-terminated polyhydrocarbon, and a combination thereof.

9. The golf display of claim 4, further comprising a curing agent that is a member selected from the group consisting of an unsaturated diol, a saturated diol, an unsaturated triol, a saturated triol, an unsaturated tetraol, a saturated tetraol, a polyol, and a combination thereof, wherein the curing agent has a molecular weight of 50 to 4,000.

10. The golf display of claim 4, further comprising a curing agent that is a member selected from the group consisting of an unsaturated diamine, a saturated diamine, a triamine, a tetramine, a polyamine, an amine- and hydroxy-containing hybrid curing agent, and a combination thereof, wherein the curing agent has a molecular weight of 50 to 5,000.

11. The golf display of claim 1, wherein the golf equipment, is selected from the group consisting of golf ball, golf club, golf shoe, and golf accessory.

12. The golf display of claim 1, further comprising a soft touch coating on a portion of the display.

13. The golf display of claim 1, further comprising a color traveling coating on a portion of the display.

14. The golf display of claim 10, further comprising a soft touch coating and a color traveling coating on a portion of the display.

15. The golf display of claim 1, wherein the display composition further comprises a soft touch material, a color traveling material, a nanopigment, or a combination thereof.
